(19) United States
(12) Patent Application Publication
(10) Pub. No.: US 2010/0299714 A1
(43) Pub. Date: Nov. 25, 2010

(54) PERSONALIZED CONTENT IN A UNIDIRECTIONAL BROADCAST STREAM

(75) Inventor: Kannan Ramasubramanian, Hyderabad (IN)

Correspondence Address: MICROSOFT CORPORATION, ONE MICROSOFT WAY, REDMOND, WA, 98052, US

(73) Assignee: Microsoft Corporation, Redmont, WA (US)

(21) Appl. No.: 12/470,491

(22) Filed: May 22, 2009

(51) Int. Cl. H04N 7/173

(52) U.S. Cl. 725/109

(57) ABSTRACT

User input associated with a user object can be received at a first computing environment connected to a bidirectional network. The user input can specify content from one or more source computing environments connected to the bidirectional network and can request that the content be included in a channel of a unidirectional broadcast stream. The content can be compiled into a bundle that is formatted to be included in the broadcast stream, and the bundle can be transmitted for inclusion in the broadcast stream.

### BACKGROUND

Most television content today is broadcast in unidirectional broadcast streams, such as unidirectional satellite transmissions, cable transmissions, and airwave transmissions. Such transmissions typically do not allow delivery of personalized content to individual consumers. Personalized content refers to content that is transmitted for inclusion in a broadcast stream in response to the content being selected by user input. The content can be selected for viewing by a selecting user and/or it can be selected by one user for viewing by another user. Existing on-demand services for unidirectional broadcasts allow users to select content from a set of content that is already included in the broadcast stream, and to view the content at times specified by users. However, users still cannot select personalized content to be included in the broadcast stream. Some less common types of television transmissions, such as IP television, are delivered over bidirectional networks, which do allow delivery of personalized content. However, such transmission types can have other drawbacks, such as higher prices, limited availability, and/or lower transmission quality.

### SUMMARY

Whatever the advantages of previous broadcasting tools and techniques, they have neither recognized the broadcasting tools and techniques described and claimed herein, nor the advantages produced by such tools and techniques.

In one embodiment, the tools and techniques can include receiving user input selecting content to be broadcast in a unidirectional television broadcast stream and user input identifying receivers of the unidirectional television broadcast stream that are authorized to present the content. One or more information packets that include the content to be broadcast and identifiers of receivers of the broadcast stream can be received over a bidirectional network.

In another embodiment of the tools and techniques, user input associated with a user object can be received at a first computing environment connected to a bidirectional network. The user input can specify content from one or more source computing environments connected to the bidirectional network and can request that the content be included in a channel of a unidirectional broadcast stream. The content can be compiled into a bundle that is formatted to be included in the broadcast stream, and the bundle can be transmitted for inclusion in the broadcast stream.

In yet another embodiment of the tools and techniques, a first request associated with a first requesting user object can be received at a computing environment connected to a bidirectional network. The first request can specify a first set of content and can request that the first set of content be included in a channel of a unidirectional broadcast stream. A second request associated with a second requesting user object can also be received at the computing environment. The second request can specify a second set of content and can request that the second set of content be included in the channel of the broadcast stream. The first set of content and the second set of content can be included in the channel of the broadcast stream.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described embodiments may be implemented.

FIG. 2 is a block diagram of a personalized content broadcasting environment.

FIG. 3 is a flow diagram of a personalized content broadcasting technique.

FIG. 4 is a flow diagram of another personalized content broadcasting technique.

FIG. 5 is a flow diagram of yet another personalized content broadcasting technique.

### DETAILED DESCRIPTION

Described embodiments are directed to techniques and tools for improved personalized content broadcasting techniques. Such improvements may result from the use of various techniques and tools separately or in combination.

Such techniques and tools may include personalizing content for a unidirectional broadcast stream. Such a broadcast stream can be a television broadcast stream, such as a cable television broadcast stream, an airwave television broadcast stream, or a satellite television broadcast stream. Personalizing content refers to allowing the content of the stream to be selected or provided by individual users, such as by providing user input to a computing environment connected to a bidirectional network, such as the Internet. Personalized content refers to content that is personalized. As used herein, personal content refers to content that is associated with a particular user object, which may be associated with one or more users. Examples of user objects include social networking website accounts, computer user accounts, email accounts, wireless telephone accounts, photo album accounts, etc. Accordingly, examples of personal content can include personal files on a user's computer, email records, online calendars and task lists, online photo albums, personal video files, etc.

In the tools and techniques, a bidirectional network can be used to provide user instructions and personalized content to an emitter of a unidirectional broadcast stream. Accordingly, a user can interact with the bidirectional network to provide the personalized content, but the content can be broadcast on a unidirectional broadcast stream (e.g., in a channel of a standard cable, airwave, or satellite television signal) and viewed by users of specified receivers, such as on standard television sets.

Accordingly, one or more substantial benefits can be realized from the personalized broadcasting tools and techniques described herein. Standard television can be a useful medium for consumers to view their personal content (e.g., their pictures, messages, voicemails etc.) because of the medium's ease of use and consumers' comfort with the medium. As described below, existing unidirectional broadcast technology can be combined with a service on a bidirectional network to allow consumers to personalize content for their viewing and set it up to be watched on their television sets, such as at a fixed time in the future.

The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Techniques described herein with reference to flowcharts may be used with one or more of the systems described herein and/or with one or more other systems. Moreover, for the sake of simplicity, flowcharts may not show the various ways in which particular techniques can be used in conjunction with other techniques.

### I. Exemplary Computing Environment

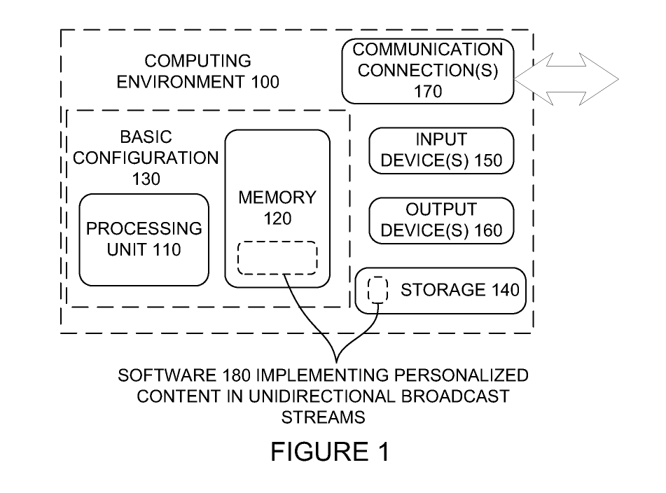

FIG. 1 illustrates a generalized example of a suitable computing environment (100) in which one or more of the described embodiments may be implemented. For example, one or more such computing environments can be used as a computing environment connected to a bidirectional network. Generally, various different general purpose or special purpose computing system configurations can be used. Examples of well-known computing system configurations that may be suitable for use with the tools and techniques described herein include, but are not limited to, server farms and server clusters, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The computing environment (100) is not intended to suggest any limitation as to scope of use or functionality of the invention, as the present invention may be implemented in diverse general-purpose or special-purpose computing environments.

With reference to FIG. 1, the computing environment (100) includes at least one processing unit (110) and memory (120). In FIG. 1, this most basic configuration (130) is included within a dashed line. The processing unit (110) executes computer-executable instructions and may be a real or a virtual processor. In a multi-processing system, multiple processing units execute computer-executable instructions to increase processing power. The memory (120) may be volatile memory (e.g., registers, cache, RAM), non-volatile memory (e.g., ROM, EEPROM, flash memory), or some combination of the two. The memory (120) stores software (180) implementing personalized content for unidirectional broadcast streams.

Although the various blocks of FIG. 1 are shown with lines for the sake of clarity, in reality, delineating various components is not so clear and, metaphorically, the lines of FIG. 1 and the other figures discussed below would more accurately be grey and fuzzy. For example, one may consider a presentation component such as a display device to be an I/O component. Also, processors have memory. The inventors hereof recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computer,” “computing environment,” or “computing device.”

A computing environment (100) may have additional features. In FIG. 1, the computing environment (100) includes storage (140), one or more input devices (150), one or more output devices (160), and one or more communication connections (170). An interconnection mechanism (not shown) such as a bus, controller, or network interconnects the components of the computing environment (100). Typically, operating system software (not shown) provides an operating environment for other software executing in the computing environment (100), and coordinates activities of the components of the computing environment (100).

The storage (140) may be removable or non-removable, and may include magnetic disks, magnetic tapes or cassettes, CD-ROMs, CD-RWs, DVDs, or any other medium which can be used to store information and which can be accessed within the computing environment (100). The storage (140) stores instructions for the software (180).

The input device(s) (150) may be a touch input device such as a keyboard, mouse, pen, or trackball; a voice input device; a scanning device; a network adapter; a CD/DVD reader; or another device that provides input to the computing environment (100). The output device(s) (160) may be a display, printer, speaker, CD/DVD-writer, network adapter, or another device that provides output from the computing environment (100).

The communication connection(s) (170) enable communication over a communication medium to another computing entity. Thus, the computing environment (100) may operate in a networked environment using logical connections to one or more remote computing devices, such as a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable storage media. Computer-readable storage media are any available storage media that can be accessed within a computing environment. By way of example, and not limitation, with the computing environment (100), computer-readable media include memory (120), storage (140), and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment. In a distributed computing environment, program modules may be located in both local and remote computer storage media.

For the sake of presentation, the detailed description uses terms like “determine,” “choose,” “adjust,” and “operate” to describe computer operations in a computing environment. These and other similar terms are high-level abstractions for operations performed by a computer, and should not be confused with acts performed by a human being, unless performance of an act by a human being (such as a “user”) is explicitly noted. The actual computer operations corresponding to these terms vary depending on the implementation.

### II. Personalized Content Broadcast System and Environment

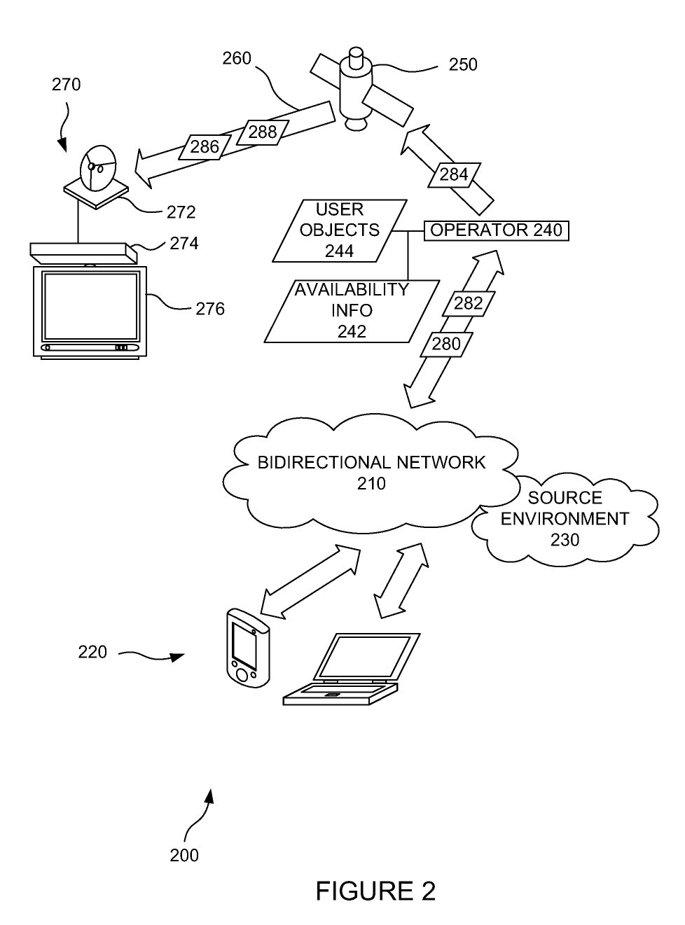

FIG. 2 is a block diagram of a personalized content broadcasting environment (200) in conjunction with which one or more of the described embodiments may be implemented. The broadcasting environment (200) can include one or more computing environments, such as the computing environments described above with reference to FIG. 1. The broadcasting environment (200) can include a bidirectional network (210). The bidirectional network (210) can include interconnected sub-networks. For example, the bidirectional network (210) can include the Internet, which can include interconnected public networks and private networks, such as wireless telephone and Internet access service networks, private local area networks connected to public networks, etc. In the bidirectional network, information can be sent to and from connected devices such as in the form of information packets, although some connected devices may only be configured to send or to receive information. For example, the information can be sent in information packets in conventional ways, such as those currently used on the Internet.

One or more user computing environments (220) can be connected to the bidirectional network (210). As used herein, a user computing environment (220) is a computing environment that can interface with one or more users, such as by using input and/or output devices. For example, such devices can include personal computers, personal digital assistants, user terminals, etc. One or more source environments (230) can also be connected to the bidirectional network (210). A source environment (230) is an environment that can act as a source of audio and/or visual content (i.e., audiovisual content), and can pass such content to the bidirectional network (210). Such content can be passed to an operator computing environment (240). For example, a source environment (230) can be a user environment (220), a web service, or a web site. Some specific examples of source environments (230) include social networking websites (Facebook, MySpace, etc.), websites with webmail and calendaring utilities (Google, Windows Live, etc.), websites that host digital photo albums, and personal user computers.

The broadcasting environment (200) can also include an operator computing environment (240), which can access availability information (242). The availability information (242) can be information about the availability of a unidirectional broadcast stream to accommodate additional personalized content. The operator environment (240) can also access user objects (244), which can be objects associated with one or more users, such as user accounts. Communications with the operator environment (240) can be associated with such user objects (244), such as by including user identifying information in requests and responses to and from the operator environment (240).

The operator environment (240) can receive content from a variety of source environments (230), including user environments (220), at the request of user input forwarded from user environments (220). For example, the user input can be received in information packets sent over the bidirectional network (210). The operator environment (240) can also compile the content from multiple sources into one or more bundles or packets that are formatted to be broadcast in a unidirectional broadcast stream. For example, the operator environment (240) may encode a photo album, a listing of contacts, a web site, and a calendar into a video file, such as an MPEG video file. Some content in source environments (230) may be protected content, such as content stored on websites that require a usemame and password to obtain access to the content. For such content, user information from the user environments (220) may include such login information (username, password, etc.), and the operator environment (240) can use that login information to retrieve the requested information from a source environment (230). For example, the operator environment (240) may interact with one or more interfaces, such as are provided by many protected websites.

The operator environment (240) can forward the bundle of personalized content to a unidirectional broadcast emitter (250). The emitter (250) can be any of various types of emitters capable of emitting a unidirectional broadcast stream (260), such as a satellite emitting a satellite television signal, an emitter of an airwave television signal, or an emitter of a cable television signal.

A user environment (220) may be configured to perform some or all of the tasks of the operator environment (240), such as retrieving content from remote source environments (230), compiling content into a bundle with an appropriate format, and forwarding the bundle to the emitter (250).

The broadcast stream (260) can be received by a standard unidirectional broadcast stream receiver (270). For example, with a satellite signal, the receiver may include a standard satellite dish (272) and a standard set top box (274) that can receive signals from the satellite dish (272). The receiver (270) can be used to provide input to a presentation device (276) for presenting the personalized content sent in the unidirectional broadcast stream (260). For example, the presentation device (276) can be a standard television set.

In use, a user environment (220) can send user input (280) over the bidirectional network (210) to the operator environment (240). For example, the user input (280) can include requests to include personalized content in a unidirectional broadcast stream. The request can specify the content to be included, the channel where it should be included, and the time for including the content in the channel. The user input (280) can also specify particular receivers that are authorized to view the content. For example, the request can specify certain user objects (244) that are authorized, and those user objects (244) can be associated with particular receivers (270) (such as receivers possessed by users corresponding to the user objects). The request can also include the content (282) itself, such as where the source of the content is a user environment (220). Alternatively, the request may include information that allows the operator environment (240) to retrieve the content from a remote source environment (230). In some situations, the content may even already be stored in the operator environment (240), such as where the operator environment (240) also includes content such as webmail or calendaring information. The user input (280) can include identifying information to associate the user input (280) with a user object (244), which can be a user account, such as a user account associated with a broadcast television subscription.

The operator environment (240) can compile the content (282) into an appropriate format if that was not already done by a user environment (220). The operator environment (240) can also send the resulting bundle (284) to the emitter (250), such as in the form of one or more packets of information. The bundle (284) can include corresponding information in addition to the content, such as indications of the time when the content of the bundle (284) is to be broadcast, and identifications of receivers (270) that are authorized to receive and present the contents of the bundle (284).

The emitter can include the contents of the bundle (284) in the broadcast stream (260), such as in a channel of the broadcast stream (260). One channel of the broadcast stream (260) may include multiple content bundles (286, 288), which can be associated with multiple user objects (244). These multiple bundles can be included in the channel during overlapping periods of time or at different times. For example, the channel may be a carousel channel, and the receiver (270) can be configured to receive and interpret the carousel channel. In a carousel channel, content in the channel is broadcast in a repeating loop. Using a carousel channel, multiple bundles of content can be broadcast on the same channel during the same period of time. Each bundle of content can include one or more identifiers of receivers (e.g., set top boxes) that are authorized to receive and access or present the content. Accordingly, if an identifier for the particular receiver (270) is associated with a content bundle in the broadcast stream (260), the receiver (270) can make the content available for presentation on the connected presentation device (276). If not, then the receiver (270) can ignore that content bundle. The carousel channel of the broadcast stream (260) can be configured as a standard carousel channel according to existing standards for carousel channels.

A channel may be associated with a particular geographical region, so that different channels with different personalized content can be provided for different geographic regions. For example, one channel may be broadcast to Portland, Oreg., while another may be broadcast to Seattle, Wash. Moreover, the broadcast stream may include multiple channels that include personalized content bundles (286, 288), even within a single geographic region.

The amount of content that can be included in a single channel at a particular time may be limited. Thus, if user input (280) requests that personalized content (282) be included in a broadcast channel at a particular time, the operator environment (240) can check the availability information (242) to determine whether sufficient availability will be present in the channel at the requested time. If not, then the operator environment (240) can return a failure notice and/or suggest a new time and/or a new channel with sufficient availability to include the requested content (282).

In addition, the operator environment (240) can check whether any receivers to be authorized to receive and present the content over the requested channel are already authorized to receive and present other content over that same channel during the same time. If so, then the operator environment (240) can return a failure notice and/or suggest a new time and/or a new channel, so that the receivers to be authorized to receive and present the content are not already authorized to receive and present other content on the same channel at the same time. Alternatively, receivers (270) may be configured to receive and present multiple bundles during a single period of time, such as by allowing a user to select between the bundles or by presenting the bundles sequentially.

### III. Techniques for Personalized Content in Unidirectional Broadcast Streams

Techniques for personalized content in unidirectional broadcast streams will now be discussed. These techniques may be implemented with the environments and systems described above or with some other environments and/or systems. In addition, the acts or operations of these techniques may be used in various combinations, with or without others of the acts or operations.

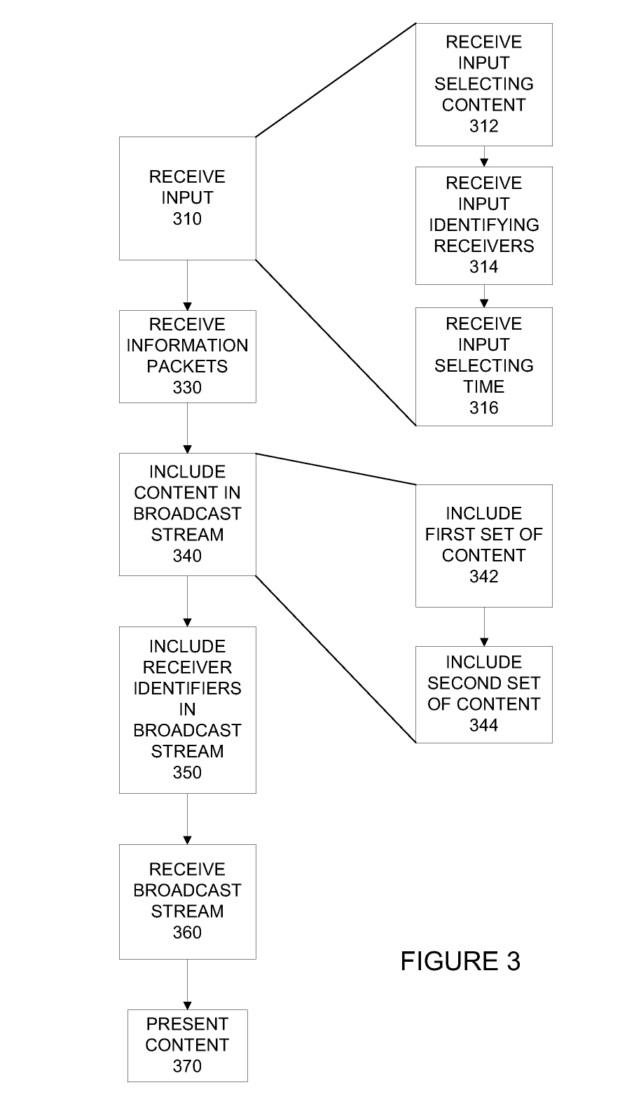

Referring to FIG. 3, a personalized content broadcasting technique will be discussed. In the technique, user input can be received (310). Receiving (310) the user input can include receiving (312) user input selecting content to be broadcast in a unidirectional television broadcast stream. Receiving (310) the user input can also include receiving (314) user input identifying one or more receivers of the unidirectional television broadcast stream that are authorized to present the content. Receiving (310) the user input can also include receiving (316) user input selecting a time for the content to be included in the broadcast stream. For example, the user input may select a time period, such as from 2:00 PM to 6:00 PM on Jan. 5, 2009 for particular content to be broadcast and available to a particular receiver on a particular channel. The user input can be associated with a user object, and one or more of the receivers can also be associated with that user object. The content can be personal content, such as personal email, calendars, or photo albums, or public content such as general web pages or videos.

Referring still to FIG. 3, the technique can also include receiving (330) information packets, such as information packets that include the content to be broadcast and/or one or more identifiers of the one or more receivers of the broadcast stream. For example, the identifier(s) of the receiver(s) can identify one or more receivers that are authorized to present the content. The information packets can also include an indication of the time for the content to be included in the broadcast stream.

The content can be included (340) in the unidirectional broadcast stream. Including (340) the content can include including (342) a first set of content in a channel in the broadcast stream during a period of time, and including (344) a second set of content in the channel during that same period of time. The first set of content can be associated with a first user object and the second set of content can be associated with a second user object.

The technique can also include including (350) identifiers of the receiver(s) in the broadcast stream. The broadcast stream can be received (360), such as being received at the receiver(s) that are identified in the broadcast stream. For example, a carousel channel in the broadcast stream may include identifiers that are associated with particular bundles of content in the channel during a particular time. The carousel channel can repeatedly broadcast all the bundles to numerous receivers, and a receiver that is identified for a particular bundle can recognize the identifier corresponding to that receiver and can make the associated content in the bundle available for presentation when a user selects the appropriate channel during the period of time when the bundle is being broadcast.

The content can also be presented (370). For example, the content can be presented using the receivers identified in the broadcast stream, as well as a presentation device such as a television set. A receiver may be incorporated in a presentation device, such as a television set. Presentation (370) may include playing a video that is included in the broadcast stream. It may also include more sophisticated and interactive presentations. For example, the receiver can store an application that can provide menus to be selected for viewing particular sets of content, and the content bundles can be configured to be utilized by that application. For example, the content bundles can include XML packages that can be rendered by applications on the receivers, in addition to providing interactive features such as menus. As one example of this, a presentation device can present a menu that can list contacts, emails, photo albums, or other sets of content, and a user can select from the menu to activate the presentation of the corresponding set of content.

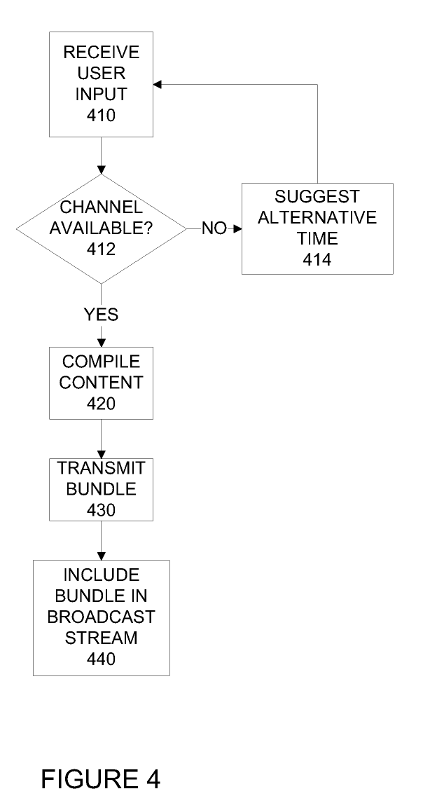

Referring now to FIG. 4, another technique for personalized content broadcasting will be discussed. In the technique, user input associated with a user object can be received (410) at a first computing environment connected to a bidirectional network. The user input can specify content from source computing environments connected to the bidirectional network and can request that the content be included in a channel of a unidirectional broadcast stream. The user input can also specify a period of time for the content to be included in the channel. The channel can be configured to carry multiple bundles during a single period of time, such as where the channel is a carousel channel.

It can be determined (412) whether sufficient availability will be present in the channel during a requested period of time. If not, the technique can include suggesting (414) an alternative time. Additional user input can be received (410) to confirm the suggested time and/or request a different time. It can be determined (412) again whether sufficient availability will still be present in the channel. If sufficient availability will be present in the channel, then the technique can include compiling (420) the content into a bundle that is formatted to be included in the unidirectional broadcast stream. In addition, the bundle can be transmitted (430) for inclusion in the unidirectional broadcast stream, such as by transmitting (430) the bundle to an operator environment and/or a unidirectional broadcast stream emitter. In addition, the bundle can be included (440) in the broadcast stream.

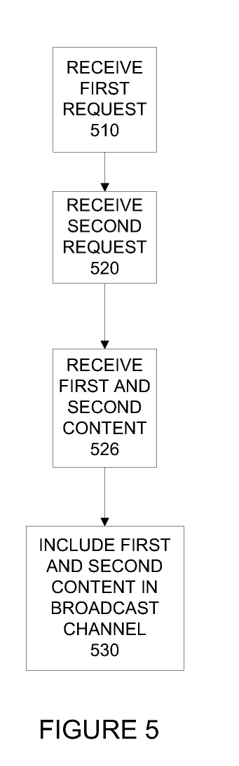

Referring now to FIG. 5, yet another technique for broadcasting personalized content in a unidirectional broadcast stream will be discussed. In the technique, a first request associated with a first requesting user object, such as a user account, can be received (510), such as where the first request is sent over a bidirectional network. For example, the request can be received (510) at a computing environment connected to the bidirectional network. The first request can specify a first set of content, and can request that the first set of content be included in a channel of a unidirectional broadcast stream.

The technique can also include receiving (520) a second request associated with a second requesting user object. The second request can also be received (520) at the computing environment, such as where the first request is received over the bidirectional network. The second request can specify a second set of content, and can request that the second set of content be included in the same channel as the first set of content. The first and second sets of content can be received (526), such as being received over the bidirectional network. In addition, the first and second sets of content can be included (530) in the channel of the broadcast stream.

Each of the requests can specify a respective period of time, and the content can be included (530) in the channel during those respective time periods. The time periods may overlap, so that both sets are included in the channel at the same time, and possibly at other additional times. The channel can be a carousel channel. In addition, the channel can be associated with a particular geographic region to which the channel is broadcast.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/we claim:

1. A computer-implemented method, comprising:
receiving user input selecting content to be broadcast in a unidirectional television broadcast stream;
receiving user input identifying one or more receivers of the unidirectional television broadcast stream that are authorized to present the content; and
receiving one or more information packets over a bidirectional network at a computing environment connected to the bidirectional network, the one or more information packets comprising the content to be broadcast and one or more identifiers of the one or more receivers of the unidirectional television broadcast stream.

2. The method of claim 1, further comprising including the content in the unidirectional broadcast stream.

3. The method of claim 1, wherein the user input selecting the content to be broadcast is associated with a user object, the user input identifying the one or more receivers is associated with the user object, and at least one of the one or more receivers is associated with the user object.

4. The method of claim 3, wherein the content comprises personal content.

5. The method of claim 1, further comprising including one or more identifiers of the one or more receivers in the unidirectional broadcast stream.

6. The method of claim 1, further comprising:
including the content in the unidirectional broadcast stream;
receiving the unidirectional broadcast stream at a receiver of the one or more receivers; and
presenting the content using the receiver.

7. The method of claim 6, wherein:
the content comprises a first set of audiovisual content associated with a first user object;
including the first set of content in the unidirectional broadcast stream comprises including the first set of content in a channel in the broadcast stream during a period of time; and
the method further comprises including a second set of audiovisual content in the channel during the period of time, the second set of content being associated with a second user object.

8. The method of claim 7, wherein the unidirectional broadcast stream comprises a carousel channel that includes the first set of content and the second set of content.

9. The method of claim 1, further comprising receiving user input selecting a time for the content to be included in the broadcast stream, wherein the one or more information packets comprise an indication of the time for the content to be included in the broadcast stream.

10. One or more computer-readable storage media having computer-executable instructions embodied thereon that, when executed, perform acts comprising:
receiving user input associated with a user object at a first computing environment connected to a bidirectional network, the user input specifying content from one or more source computing environments connected to the bidirectional network and requesting that the content be included in a channel of a unidirectional broadcast stream;
compiling the content into a bundle that is formatted to be included in the unidirectional broadcast stream; and
transmitting the bundle for inclusion in the channel of the unidirectional broadcast stream.

11. The one or more computer-readable media of claim 10, wherein the acts further comprise including the bundle in the channel of the unidirectional broadcast stream.

12. The one or more computer-readable media of claim 11, wherein the wherein the acts further comprise including multiple bundles in the channel during a single period of time.

13. The one or more computer-readable media of claim 10, wherein the user input specifies content from a plurality of source computing environments connected to the bidirectional network.

14. The one or more computer-readable media of claim 10, wherein the user input specifies a period of time for the content to be included in the channel.

15. The one or more computer-readable media of claim 14, and wherein the acts further comprise:
determining whether the channel is available to include the content during the period of time; and
suggesting an alternative time if the channel is not available to include the content during the period of time.

16. One or more computer-readable storage media having computer-executable instructions embodied thereon that, when executed, perform acts comprising:
receiving at a computing environment connected to a bidirectional network a first request sent over the bidirectional network, the first request being associated with a first requesting user object, and the first request specifying a first set of content and requesting that the first set of content be included in a channel of a unidirectional broadcast stream;
receiving at the computing environment a second request sent over the bidirectional network, the second request associated with a second requesting user object, and the second request specifying a second set of content and requesting that the second set of content be included in the channel of the unidirectional broadcast stream; and
including the first set of content and the second set of content in the channel of the unidirectional broadcast stream.

17. The one or more computer-readable media of claim 16, wherein:
the first request specifies a first period of time;
the second request specifies a second period of time; and
including the first set of content and the second set of content in the channel comprises including the first set in the channel during the first period of time and including the second set in the channel during the second period of time.

18. The one or more computer-readable media of claim 16, wherein the acts further comprise receiving the first set of content over the bidirectional network and receiving the second set of content over the bidirectional network.

19. The one or more computer-readable media of claim 16, wherein the channel is a carousel channel.

20. The one or more computer-readable media of claim 16, wherein the channel is associated with a geographic region to which the channel is broadcast.
